(19) United States
(12) Patent Application Publication
(10) Pub. No.: US 2004/0027007 A1
(43) Pub. Date: Feb. 12, 2004

(54) Double-axis double-speed linear motor mechanism

(76) Inventor: Yung - Tsai Chuo, Taichung (TW)

Correspondence Address: CHARLES E. BAXLEY, ESQUIRE, Hart, Baxley, Daniels & Holton, 59 John St, 5 Fl, New York, NY, 10038, US

(21) Appl. No.: 10/216,641

(22) Filed: Aug. 12, 2002

(51) Int. Cl. H02K 41/00

(52) U.S. Cl. 310/12

(57) ABSTRACT

The present invention relates to a linear motor mechanism that has two axles, a tool-axle and a work-piece-axle, and the two axles parallel to each other. When one of said two axes moves, the other axle moves in the against direction. The tools set up on the tool-axle and the work pieces set up on the work-piece-axle, so between the tool and work piece of the present invention can has double relative velocity and acceleration to the prior art. Since between the tool and work piece the relative velocity and acceleration is good, the mechanism can reduce the working time. And, the mechanism will improve the mechanical characteristic of mechanism.

### FIELD OF THE INVENTION

The present invention relates to a double-axis double-speed linear motor mechanism, especially to the machine that is required to move quickly to the work pieces and tools, such as high speed sculpturing machine, PCB drill, the rapid proto-typing machine or other electronic parts production equipment.

### BACKGROUND OF THE INVENTION

In order to increase the work efficiency of machine, the stroke time of each movement of the machine needs to be reduced and the movement speed and acceleration of the moving mechanism need to be increased. The relative speed and acceleration between the tools and the work pieces especially need to be increased because they are the key points of the efficiency.

Nevertheless, there is a limitation to increase the movement speed of the mechanism. Using a high-speed servomotor, a belt valley transmission mechanism to increase revolutions per minute, using a high-lead screw shaft, or using high-speed linear motor to drive the mechanism is one of the ways to increase the speed and acceleration. There are shortcomings for those conventional ways.

In order to proceed the operation at high speed, not only the speed but the acceleration have to be increased, otherwise, the speed of the mechanism begins to slow down before the a maximum speed between the work piece and tool is reached. Even if the maximum speed is reached, the maximum speed can only kept a short period of time such that the mechanism works at the maximum speed only a short period of time and saves limited time.

Accordingly, not only the maximum speed has to be increased, the high acceleration is also important. In those ways to increase the speed, the linear motor can make the maximum speed and acceleration. The maximum acceleration for high-speed linear motor is about 4G (G represents gravity acceleration). The table usually has a huge mass so that it is difficult to accelerate the heavy table to 4G. Because the acceleration is not high enough so that the table starts to reduce its speed before a maximum speed is reached. Accordingly, the travel that the table is moved at the maximum speed is very limited. The conventional high-speed machining mechanism needs to be improved.

The present invention intends to provide a double-axis double-speed linear motor mechanism that has higher speed and acceleration so that the relative speed between the work piece and tools is double with respect to conventional speed and the acceleration is double. This allows the speed and acceleration of machining to be increased and meets the requirement of shortening machining time from the present market.

### SUMMARY OF THE INVENTION

The present invention is provides a double-axis double-speed linear motor mechanism that has a base on which a work piece platform assembly and a tool fixture assembly are connected. The work piece platform is movable toward a first axle which is parallel with the base. The tool fixture assembly has tools installed thereon which are movable along the direction of the first axle. In order to increase the relative speed and acceleration between the tools and the work pieces so as to save the machining time, the work piece platform moves in one direction of the first axle and the tool moves to another direction along the first axle, such that the speed between the work piece platform and the tool is the sum of the speed of the work piece platform relative to the base and the speed of the tool relative to the base. The speed between the work piece platform and tool is twice as much as the speed of the conventional speed, the acceleration between the work piece platform and the tool is also twice as much as the speed of the conventional acceleration. This is benefit for increasing the mechanism and reducing the time of movement.

Linear motor is employed to drive the work piece platform and the tool so as to increase the desired speed of the double-axis double-speed linear motor mechanism. For the conventional linear motor, the speed between the work piece platform and the base can be up to 120 meters per minute, and the acceleration can be up to 1G. In the present invention, the speed and acceleration between the tool and the base can be the same to conventional case, and the speed and acceleration between the work piece platform and the base too. So, the relative speed between the work piece platform and tool can reaches 240 meters per minute, and the relative acceleration can reaches 2G.

Because the power supplies for driving the work piece platform and the tools are independent so that the total weight of the present invention is not heavier than the conventional. The speed and the acceleration can reach the desired value so that the speed and the acceleration of the double-axis double-speed linear motor mechanism are double to the conventional ones.

For the present invention, one perhaps thoughts that the power supply for driving double axes becomes two power supplies so that the cost will be double. However, the cost is just a minor portion of the total cost for the mechanism. The slightly increase for the power supply is worthy. The driving by only one direction is changed into two driving in two opposite directions; the stroke of the power axle is reduced in half. This reduces the cost so that the final cost is increased slightly and the efficiency is increased dramatically, which is worthy.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a double-axis double-speed linear motor mechanism of the present invention, and

FIG. 2 shows a right side view of the double-axis double-speed linear motor mechanism of the present invention.

### DETAILED DESCRIPTION OF THE PREFERRED EMBODIMENT

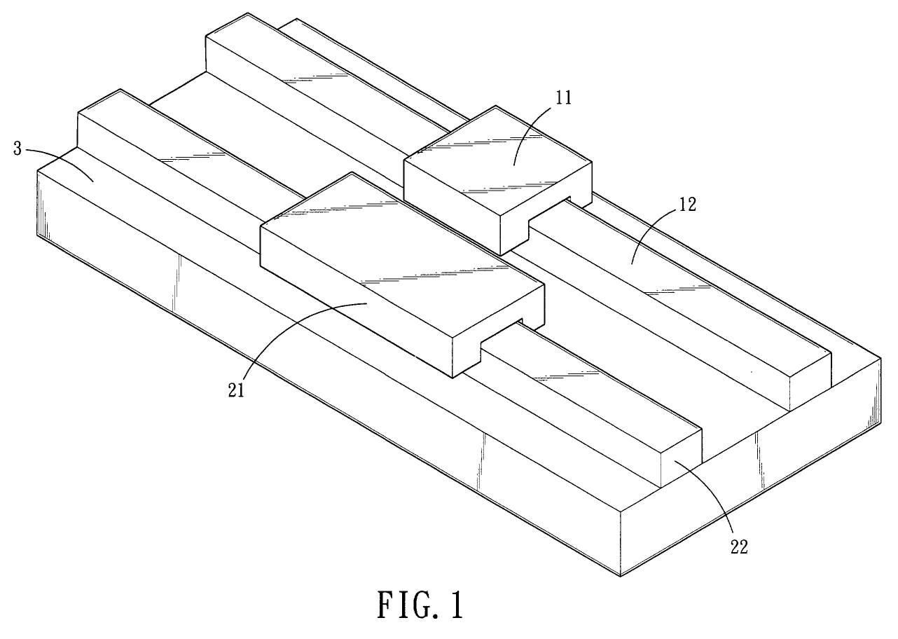

Referring to FIG. 1 which shows a double-axis double-speed linear motor mechanism of the present invention and comprises a base 3 on which a work piece platform 21 for carrying work pieces and the work piece driving shaft 22 are connected, wherein the work piece platform 21 and the work piece driving shaft 22 are called as a work piece platform assembly. A tool fixture 11 for fixing a tool and a tool driving shaft 12 are connected to the base 3. The tool fixture 11 and the tool driving shaft 12 are called as a tool fixture assembly. The tool driving shaft 12 is connected to the base 3 and located parallel with the surface of the base 3. The work piece platform 21 is connected to the work piece driving shaft 22 and movable along the work piece driving shaft 22. For convenience of description, the work piece driving shaft 22 is named as the first axle. The tool fixture 11 is connected to the tool driving shaft 12 and movable along the driving shaft 12. The tool driving shaft 12 and the work piece driving shaft 22 are moved in parallel with each other. When the work piece platform 21 moves toward the first axle, the tool fixture 11 is moved to the opposite direction on the first axle. The relative speed between the work piece platform 21 and the tool fixture 11 is the sum of the relative speed between the work piece platform 21 and the base 3 and the relative speed between the tool fixture 11 to the base 3. The relative acceleration between the work piece platform 21 and the tool fixture 11 is the same as the sum of the relative acceleration between the work piece platform 21 and the base 3 and the relative acceleration of the tool fixture 11 and the base 3. The relative speed between the work piece platform 21 and the tool fixture 11 is twice as the relative speed of the conventional mechanism, the relative acceleration between the work piece platform 21 and the tool fixture 11 is double as the relative acceleration of the conventional mechanism.

In order to have the desired speed and acceleration, the mechanism of the present invention employs linear motor to drive the work piece platform 21 and the tool fixture 11. The two respective power supply for driving the work piece platform 21 and the tool fixture 11 are independent, and the object to be machined is similar to that used on the conventional mechanism so that the relative speed and relative acceleration between the work piece platform 21 and the tool fixture 11 can be double to those for the conventional mechanism.

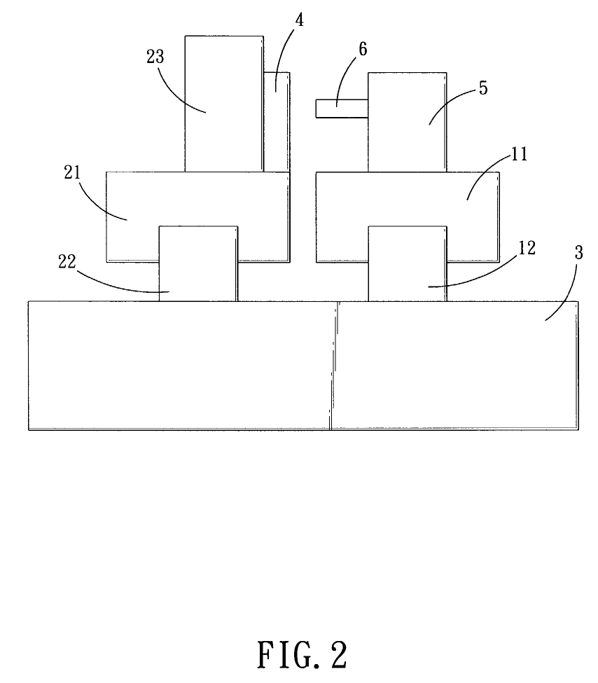

FIG. 2 shows a right side view of the double-axis double-speed linear motor mechanism of the present invention and what is disclosed in an embodiment of the present invention. In this embodiment, the work piece fixing base 23 is put on the work piece platform 21 and the work piece 14 is put on the work piece fixing base 23. The tool fixture 11 has tool shaft 5 which drives the tool 6 to access to or move away from the work piece as shown the left and right direction in FIG. 2. This is an embodiment of the mechanism as shown in FIG. 1 and is used for those which has slower machining speed and requires high speed to position the tool such as the PCB drill. The tool 6 and the work piece 4 in this embodiment may move at a high relative speed and the machining axle is remained as conventional feeding speed. This results in double axes and double speed in the direction of the work piece driving shaft 22 such that the efficiency is increased.

The present invention has the following advantages when comparing with the conventional mechanism:

1. The work piece driving shaft and the tool driving shaft move relative to the base simultaneously in opposite directions so that the relative speed for the work piece on the work piece driving shaft and the tool on the tool driving shaft is double to the relative speed of the tool driving shaft to the base. The relative speed of the work piece to the tool is double to the relative speed of the conventional mechanism.

2. The work piece driving shaft and the tool driving shaft are independent so that there will be no interference between the acceleration between the work piece driving shaft and the tool driving shaft. When the work piece driving shaft and the tool driving shaft move in opposite directions, the relative acceleration is the sum of the relative acceleration between the work piece driving shaft and the tool driving shaft for conventional mechanism. The relative acceleration between the work piece and the tool is increased.

3. The present invention the linear motor for the work piece platform and the tool and the linear motor has better speed and acceleration, so that the mechanism of the present invention reaches the desired speed and acceleration.

While we have shown and described the embodiment in accordance with the present invention, it should be clear to those skilled in the art that further embodiments may be made without departing from the scope of the present invention.

What is claimed is:

1. A double-axis double-speed linear motor mechanism, comprising:
a base;
a work piece platform assembly connected to said base and including a work piece platform for work pieces to be put thereon, said work piece platform movable toward a first axle which is parallel with a surface of said base, and said work piece platform driven by a linear motor; and
a tool fixture assembly connected to said base and having a tool which can movable along the direction of said first axle, said tool fixture driven by a linear motor, when said work piece platform moves in a direction of said first axle, said tool move to another direction on the direction of said first axle so that said work piece platform and said tool can move at high speed relatively.

2. The mechanism as claimed in claim 1, wherein said linear motor for driving said work piece platform and said linear motor for driving said tool fixture is independent.

3. The mechanism as claimed in claim 2, wherein the direction that said tool moves is parallel with said base and perpendicular to said first axle.
